(19) United States
(12) Patent Application Publication
(10) Pub. No.: US 2004/0091660 A1
(43) Pub. Date: May 13, 2004

(54) Article of personal communication and a sheet material for separating such an article therefrom

(75) Inventor: Barry D. Berger, New York, NY (US)

Correspondence Address: Arthur F. Dionne, Esq., McCormick, Paulding & Huber LLP, City Place II, 185 Asylum Street, Hartford, CT, 06103, US

(73) Assignee: SOUTHWORTH COMPANY, Agawam, MA

(21) Appl. No.: 10/292,100

(22) Filed: Nov. 12, 2002

(51) Int. Cl. G09F 3/00

(52) U.S. Cl. 428/43; 428/124

(57) ABSTRACT

A sheet material is provided for receiving a predetermined image printed by a printer having a plurality of rollers that selectively engage gutter areas of the sheet material. The sheet material includes a primary panel and a flap defined on the sheet material, the flap and the primary panel being mated about a common fold line. The primary panel and the flap are detachable from the sheet material via an inscribed line of detachment forming a boundary of the primary panel and the flap. Either the primary panel or the flap is, at least, partially defined in the gutter areas of the sheet material.

### FIELD OF THE INVENTION

The present invention relates generally to paper sheet materials, such as personal copier paper, and deals more particularly with paper sheet materials upon which are defined various articles of personal communication, such as business cards, self-mailing envelopes, and the like. More particularly, the present invention is directed towards thin stock sheet material suitable for use with computer compatible desktop-type printers, wherein the thin stock sheet material includes micro-perforations, score lines, and the like for removing the articles therefrom.

### BACKGROUND OF THE INVENTION

Business cards, self-mailing envelopes, greeting cards, and other articles of personal communication are generally printed on heavy stock paper, especially in the business arena, in order to project an aura of professionalism and style. Over the years, people have become accustomed to the rigidity and durability of heavy stock paper and typically turn to commercial printers to design and produce articles of communication employing the same.

The rationale for utilizing commercial printers is multi-faceted. Firstly, commercial printers can easily accommodate the large number of items typically requested by a customer, oftentimes numbering in the thousands for business card orders and the like. Moreover, commercial printers employ print machinery, not readily available to most end-users and non-commercial vendors, which is structurally capable of manipulating and printing upon the heavy stock paper preferred in the business arena.

There are, however, a myriad of instances where a commercial printing run is not economically justified by the number of articles needed. For example, personalized greeting cards, business cards tailored to a one-time event or trade show, and business cards with a temporary address may each be limited to such small quantities that employing a commercial printer would incur an excessive expenditure per printed item. Furthermore, commercial printing typically demands more lead-time than may be available in certain situations. For these and other reasons, a viable alternative to commercial printers would be desirable.

Given their near ubiquitous profile, computer compatible printers would be ideal, alternative candidates for the production of various articles of personal communication as these printers typically already carry the print and graphics capacity for the vast majority of desired applications. The personal printers now on the market, however, lack the capacity to handle heavy stock paper, instead utilizing a lighter stock of paper upon which to print.

Computer compatible printers, including the majority of home printers, have a variety of closely spaced and oppositely driven pinch rollers which draw in and manipulate individual pages of paper. The spacing of these pinch rollers conform to close tolerances in order to handle the most commonly utilized papers. In operation, paper that is too thin will slip relative to the rollers and not be properly indexed to the printhead, while paper that is too thick can jam in the rollers or cause excessive wear to the rollers and their mountings. Moreover, in the never-ending quest to miniaturize components, the diameter of the rollers utilized in most home printers have become so small that heavy stock paper may be incapable of conforming to such a tight curvature of diameter.

Computer compatible home printers are also designed to include circuitous paper paths through the machine to enable multi-pass or two-sided printing on the same sheet of paper or some multi-color printing. The more circuitous paper route further frustrates using heavy stock paper in such printers because an otherwise proper printing may be smeared when the paper passes through pinch rollers on the exit side of the printhead before the toner or ink is fully dry. This latter problem is particularly vexing because smudges on the rollers themselves are difficult to clean and adulterate later printed pages.

With the forgoing problems and concerns in mind, it is the general object of the present invention to utilize thin stock sheet material to produce various articles of personal communication, thereby taking advantage of the capabilities of readily available computer compatible printers.

### SUMMARY OF THE INVENTION

One embodiment of the present invention is an article of personal communication made from a single layer of sheet material comprising a primary panel for displaying a primary message, and a flap fixed to the primary panel at a first fold line, wherein the flap is folded along the first fold line to lie behind the primary panel.

Another embodiment of the present invention is a single layer of sheet material comprising a waste area, at least one article of personal printed communication, and at least one score line disposed between the waste area and the article. The article itself comprises a primary panel defining a display face, a first flap, and a first fold line between the primary panel and the first flap.

In a preferred embodiment of the sheet material, at least a first and a second article comprise the sheet material, each article comprising a first flap, a primary panel defining a display face, and a first fold line between the primary panel and the first flap. In this preferred embodiment, a first score line is disposed between the waste area and the first flap, a second waste area score line is disposed between the waste area and the second flap, and a first separation line is disposed between the first article and the second article.

In a most preferred embodiment of the sheet material, a sheet material is provided for receiving a predetermined image printed by a printer having a plurality of rollers which selectively engage gutter areas of the sheet material. The sheet material includes a primary panel and a flap defined on the sheet material, the flap and the primary panel being mated about a common fold line. The primary panel and the flap are detachable from the sheet material via an inscribed line of detachment forming a boundary of the primary panel and the flap. Either the primary panel or the flap are at least partially defined in the gutter areas of the sheet material.

Moreover, another aspect of the present invention lies in the ability to constructively utilize that area of a sheet of copier paper which cannot be printed upon due to the action of the print rollers on the copier paper within the typical, home printer.

### BRIEF DESCRIPTION OF THE DRAWINGS

FIG. 1A shows a plan view of the preferred embodiment of the present invention, a business card.

FIG. 1B is a sectional view along line 1B but with the article folded.

FIG. 2A shows a plan view of the first alternative embodiment.

FIG. 2B is a sectional view along line 2B but with the article folded.

FIG. 3A shows a plan view of the second alternative embodiment.

FIG. 3B is a sectional view along line 3B but with the article folded.

FIG. 4A shows a plan view of the third alternative embodiment.

FIG. 4B is a sectional view along line 4B but with the article folded.

FIG. 5A shows a plan view of the fourth alternative embodiment.

FIG. 5B is a sectional view along line 5B but with the article folded.

FIG. 6A shows a plan view of the fifth alternative embodiment.

FIG. 6B is a sectional view along line 6B but with the article folded.

FIG. 7A shows a plan view of the sixth alternative embodiment.

FIG. 7B is a sectional view along line 7B but with the article folded.

FIG. 8 shows a plan view of the seventh alternative embodiment.

FIG. 9 shows a plan view of the eighth alternative embodiment.

FIG. 10 shows a plan view of the ninth alternative embodiment, a self-mailer, disposed on a sheet material.

FIG. 11 shows a plan view of the article of FIG. 10 separated from the sheet material and partially folded.

FIG. 12 shows a plan view of the article of FIG. 11 fully folded.

FIG. 13 shows a perspective view of the article of FIG. 10 in the process of being folded.

FIG. 14 shows a plan view of the tenth alternative embodiment, a self-mailer, disposed on a sheet material.

FIG. 15 shows a plan view of the article of FIG. 14 separated from the sheet material and partially folded.

FIG. 16 shows a plan view of the article of FIG. 15 fully folded.

FIG. 17 shows a perspective view of the article of FIG. 14 in the process of being folded.

FIGS. 18A-D each show a plan view of an edge variation that may be incorporated into any of the embodiments of the present invention.

FIG. 19 shows a plan view of a sheet material adapted so that a plurality of articles according to the preferred embodiment may be removed therefrom.

### DETAILED DESCRIPTION OF THE PREFERRED AND ALTERNATIVE EMBODIMENTS

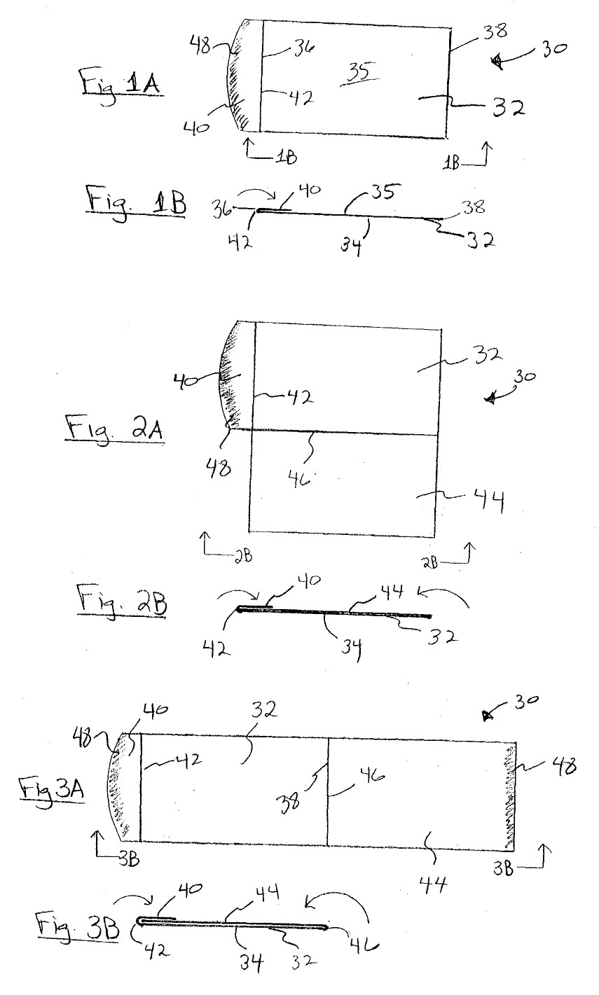

A fuller appreciation for the present invention may be achieved by reference to the associated illustrations, wherein FIGS. 1A and 1B depict an article of personal communication 30, according to the preferred embodiment of the present invention. The article 30 is in the form of a business card and comprises a primary panel 32 that defines a display face 34 for displaying a visual message such as text or graphics, a first edge 36 and a second edge 38. The article 30 further comprises a first flap 40 fixed to the primary panel at a first fold line 42. The first fold line 42 is not a mere marking or printed line but is a line of reduced rigidity as compared to other portions of the article, such as may be formed by pre-folding a paper or otherwise perforating some but not all of the paper fibers along a given fold line. The fold lines may or may not also include printed markings such as a line formed by ink or toner.

FIG. 1B shows the finished article of FIG. 1A wherein the first flap 40 is folded along the first fold line 42 to lie behind the primary panel 32 opposite the display face 34. This figure also shows that the first edge 36 of the primary panel 32 is coincident with the first fold line 42. The two separate layers of primary panel 32 and first flap 40 are exaggerated in FIG. 1B, and a gap is imposed between them, to better illustrate their relation when folded. An adhesive 48 may be disposed on at least a portion of the first flap to secure the first flap to the primary panel opposite the display face. The additional thickness imposed on the article by folding the flap back onto the primary panel gives the relatively thin stock of the article more rigidity to better approximate that of a commercially produced business card. However, the thin stock used in the present invention is printable on standard printers commonly used and available in the home or office without binding internal pinch rollers of those printers. While the display face 34 has been described as displaying a visual message, the opposing face 35 of the primary panel may also carry such a message, as well as the face of the first flap that remains visible once the article is folded.

FIG. 2A shows an article similar to that of FIG. 1A but further including a rear panel 44 fixed to the primary panel 32 at a rear panel fold line 46 that is perpendicular to the first fold line 42 in this particular embodiment. FIG. 2B shows the folded article, wherein the rear panel 44 is folded along the rear panel fold line 46 first to lie immediately behind the primary panel 32, and the first flap 40 is subsequently folded along the first fold line 42 to overlie the rear panel 44 behind the primary panel 32. Alternatively, the flap may be folded in first followed by the rear panel. Both the rear panel and the flap, or either of them, may include an adhesive 48 on at least a portion thereof. This embodiment provides an additional layer of thickness as compared to the preferred embodiment.

FIG. 3A shows a variation from FIG. 2A, wherein the rear panel fold line 46 is parallel to the first fold line 42 and coincident with the second edge 38 of the primary panel 32. FIG. 3B shows that a portion of the rear panel is sandwiched between the primary panel and the first flap, but as above with FIG. 2, the particular folding sequence is not limiting to the invention.

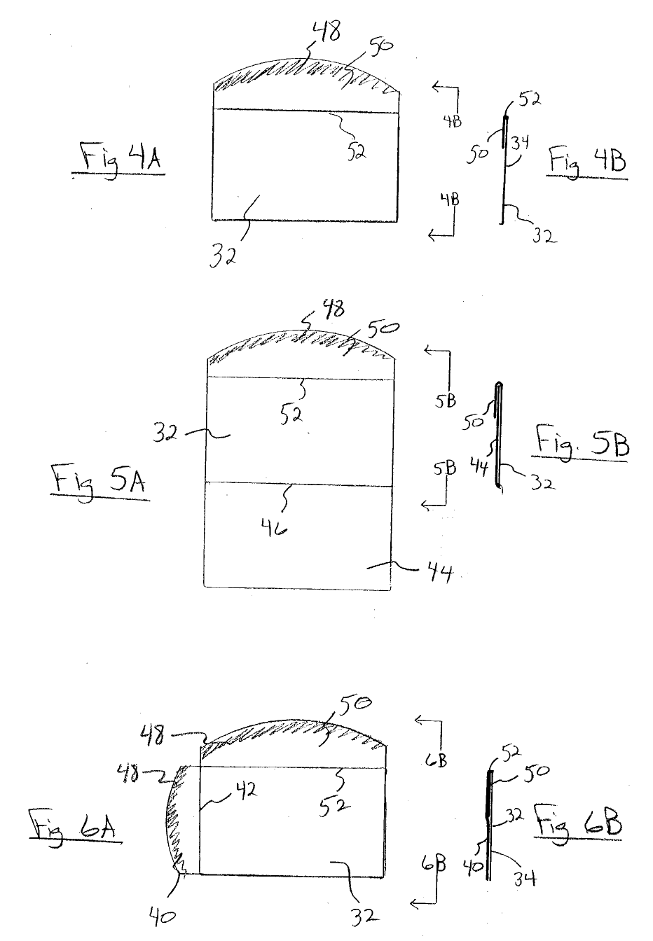

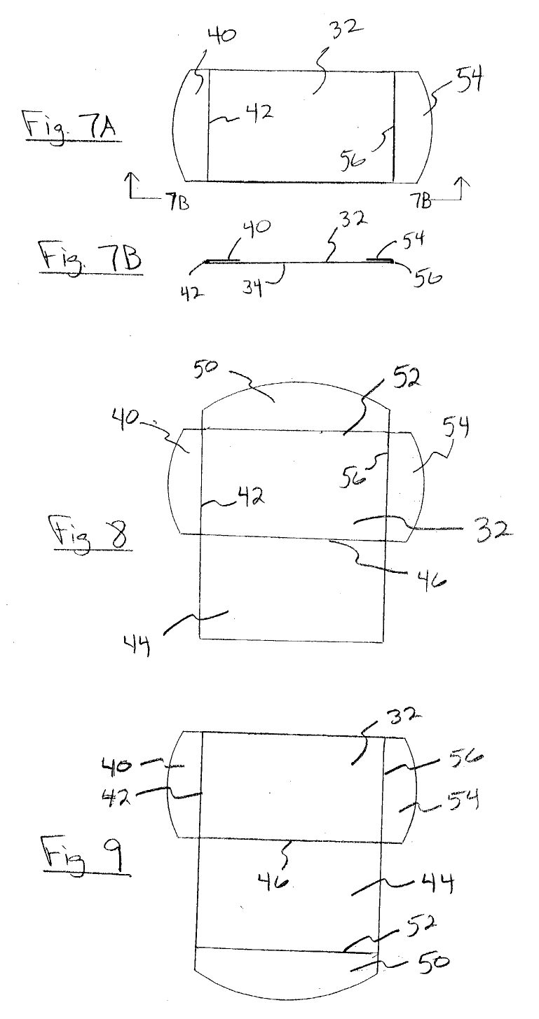

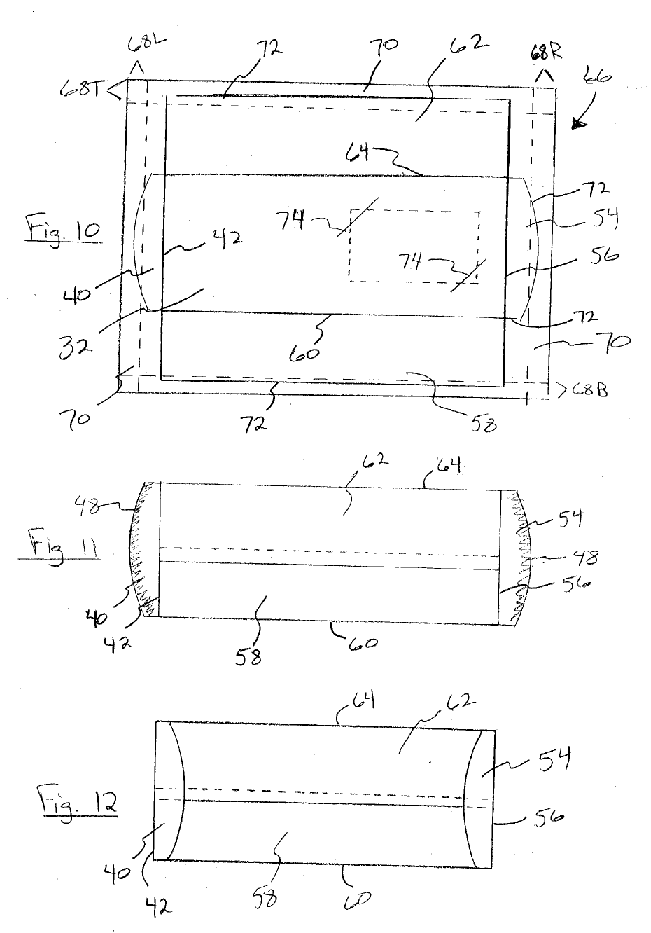

FIG. 4A shows a variation from FIG. 1, wherein the flap is herein termed a broad flap 50 separated from the primary panel 32 by a broad fold line 52. The sectional view of FIG. 4B, as well as FIGS. 5B and 6B, is taken from a different angle as compared to previous drawings to better show the relationship of the components as folded. An adhesive 48 may be applied to at least a portion of the broad flap in a manner and for a purpose similar to that described above. The broad flap 50 is folded to lie behind the primary panel 32 opposite the display face 34.

Similar to the variation of FIG. 3 as compared to FIG. 1, FIG. 5A varies from FIG. 4A by further including a rear panel 44 fixed to the primary panel 32 at a rear panel fold line 46. The broad fold line 52 is parallel to the rear panel fold line 46 in this embodiment, and FIG. 5B depicts a portion of the rear panel 44 sandwiched between the broad flap 50 and the primary panel 32. As above, the folding sequence may be varied and adhesive may be added at the flap and/or the rear panel. Each of the embodiments of FIGS. 2, 3 and 5 offer the advantage that printed material may be printed on the same face of the primary panel, the rear panel, and the flap, and the article will be printed on both sides when folded. This is particularly beneficial wherein the user's printer is of the desktop or home office variety, rather than an office style multi-function copier/printer that is capable of automatically printing on both sides of a page.

FIG. 6A shows a business card with a primary panel 32, a first flap 40 separated from the primary panel by a first fold line 42, and a broad flap 50 separated from the primary panel 32 by a broad fold line 52. FIG. 6B shows the broad flap 50 folded behind the primary panel first, followed by the first flap 40. This embodiment stiffens the article in two perpendicular directions with minimal use of material. FIG. 6B shows an overlap of the broad flap 50 with the first flap 40 when they are both folded. Such an overlap can be avoided if desired by tailoring the shape of the flaps to abut but not overlie each other when folded.

FIG. 7A depicts another embodiment of the article wherein a first flap 40 and a second flap 54 are separated from a primary panel 32 by a first fold line 42 and a second fold line 56, respectively. In the embodiment shown, the first and second fold lines 42 and 56 are parallel to one another. When folded as shown in FIG. 7B, it is apparent that the second flap provides additional stiffness to the end of the article that is opposite the first flap.

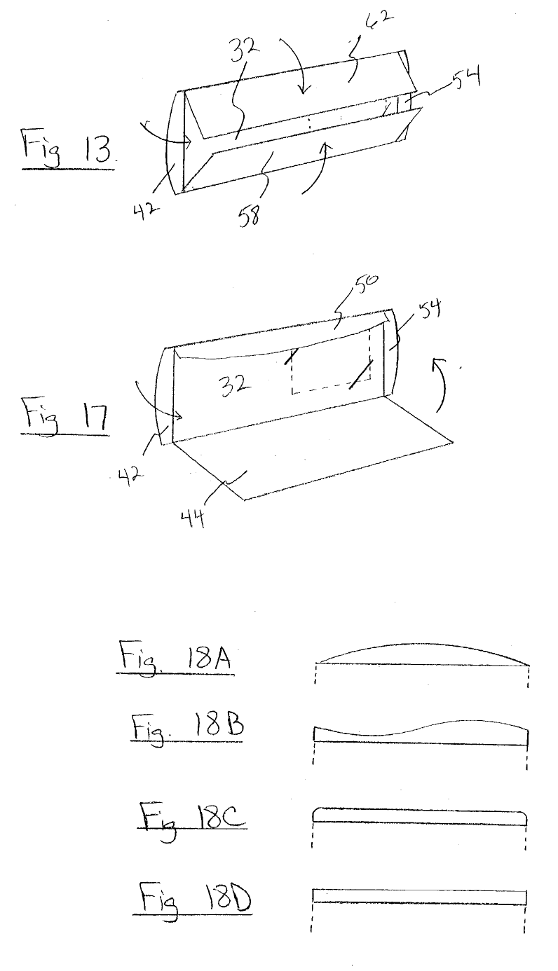

FIG. 8 illustrates another embodiment wherein a rear panel 44 and a broad flap 50 are added to the embodiment of FIG. 7, the rear panel 44 separated form the primary panel 32 by a rear panel fold line 46, and the broad flap 50 separated from the primary panel 32 by a broad fold line 52. The embodiment of FIG. 8 is arranged such that the first 42 and second 56 fold lines are parallel to one another, and the broad fold line 52 and the rear panel fold line 46 are each adjacent to both the first and second fold lines. The embodiment of FIG. 9 includes the same components as that of FIG. 8 arranged so that the broad fold line 52 is not adjacent to either the first 42 or the second 56 fold lines. However, both embodiments of FIGS. 8 and 9 orient the broad fold line 52 and the rear panel fold line 46 parallel to one another and perpendicular to the first 42 and second 56 fold lines.

FIG. 10 shows an article according to the ninth embodiment, a self-mailer comprising a primary panel 32, a lower rear panel 58 separated from the primary panel by a third fold line 60, an upper rear panel 62 separated by a fourth fold line 64, wherein the third and fourth fold lines are parallel to one another. The self-mailer further comprises a first flap 40 and a second flap 54 separated from the primary panel by a first fold line 42 and a second fold line 56, respectively. The first and second fold lines are parallel to one another, and the upper and lower rear fold lines are each adjacent to both the first and second fold lines. The largest area defined by the lower rear panel defines (the area depicted in FIG. 10) added to the largest area defined by the upper rear panel (the area depicted in FIG. 10) is greater than the largest area of the primary panel (the area depicted in FIG. 10 and bounded by lines 42, 64,56 and 60). The purpose of this area differential will be described in relation to FIG. 11.

The self-mailer of FIG. 10 is disposed on a sheet material 66 such as a single page of paper. Any such sheet material defines four gutters about its marginal edges, herein termed a left gutter 68L, a right gutter 68R, a top gutter 68T and a bottom gutter 68B. The gutter is that portion of the marginal edge of a sheet material that is not subject to being printed upon by computer compatible printers. Computer compatible printers are herein limited to printers with widespread use beyond the commercial printing business, and specifically including desktop printers and multi-function printers (printer/fax/copier, etc.) commonly used by nearly all businesses and by many individuals in their homes. For the purposes herein, the gutter is a strip of the sheet material extending from a marginal edge of the sheet material to a line 0.5″ inboard of the edge. A narrow gutter is herein defined as a strip extending from the marginal edge to a line 0.3″ inboard of the marginal edge.

The portion or portions of the sheet material 66 that does not form part of the article is herein termed the waste area 70. The waste area is separated from the article, the self-mailer of FIG. 10, by a plurality of waste area score lines 72. Waste area score lines, and every score line used herein, differs from a fold line in that every score line includes an incomplete breach such as a cleft, a groove, a series of spaced perforations, or some other degradation of the integrity of the sheet material that facilitates separation along the score line. Examples include a razor cut that penetrates partly but not fully through the thickness of the sheet material, or a series of micro-perforations penetrating through the material and arranged in a closely spaced curvilinear pattern. The purpose of the score lines is to readily remove the waste area from the article, or remove one article from another, along the score lines without having to cut the sheet material with another implement like scissors or a razor. While the sheet material may be separated along a fold line as well as along a score line, the difference is a matter of degree and intent. Fold lines are not for the purpose of separation and so the sheet material would show a greater propensity to tear along a score line than a fold line. Furthermore, fold lines typically do not degrade the thickness of the sheet material whereas score lines typically do.

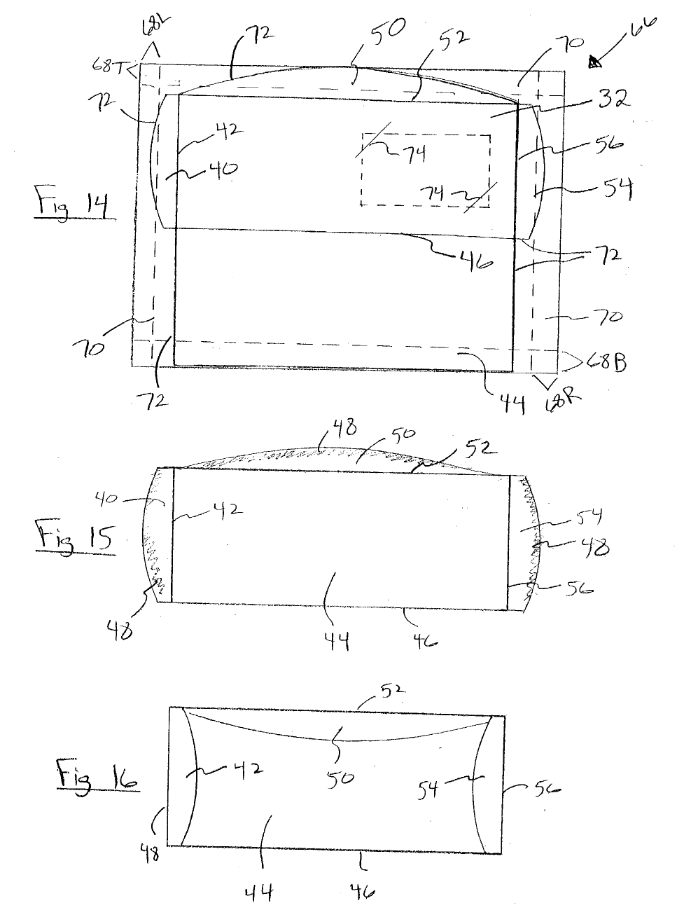

For the mailer of the relative size depicted in FIG. 10, the sheet material is a standard 8.5″×11″ size and the first and second flaps lie at least partially within the left and right gutters 68L and 68R, respectively. The primary panel 32 further may include a pair of slits 74 for retaining a business card or some other removable flat material as shown in shadow. FIG. 11 depicts the self-mailer of FIG. 10 with the lower 58 and upper 62 rear panels folded in the foreground over the primary panel (not shown) in the background. A portion of the lower rear panel 58 is sandwiched between the primary panel in the background and the upper rear panel 62 in the foreground, and either of the rear panels may include an adhesive 48 to seal them together in this overlapping area, such as the adhesive shown on the flaps 40 and 54. In order to overlap each other and fully cover the primary panel, the cumulative areas of the upper and lower rear panels must exceed the area of the primary panel as discussed above. FIG. 12 completes the self-mailer wherein the first 40 and second 54 flaps are folded inwardly over the upper 62 and lower 58 rear panels. Adhesive may also be disposed on the flaps for self-sealing. FIG. 13 is a perspective view of the self-mailer of FIGS. 10-12 separated from the waste area and in the process of being folded.

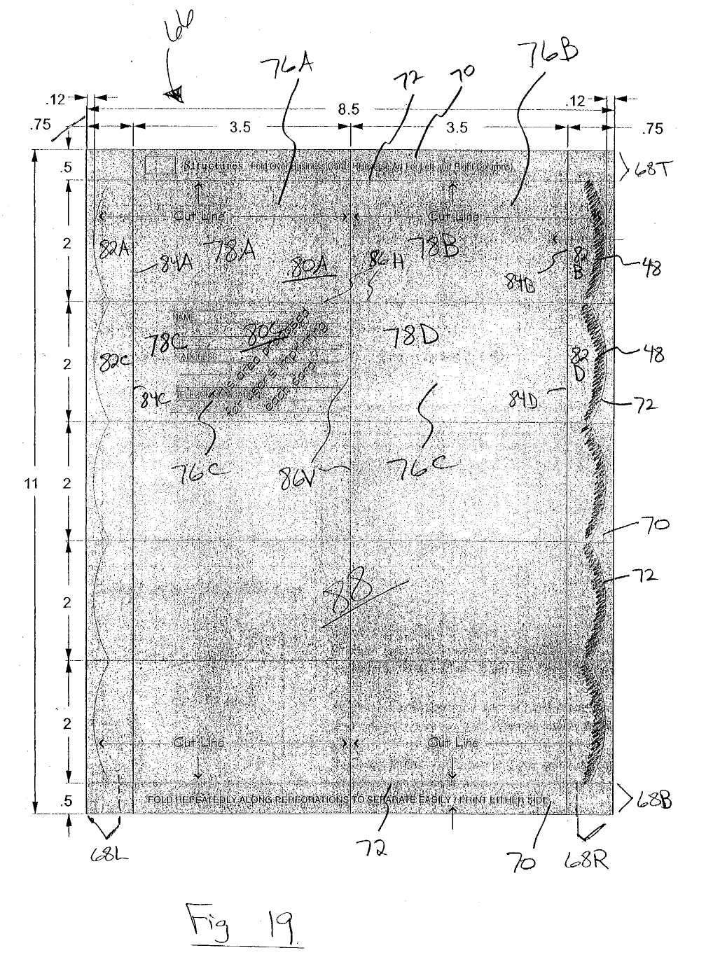

Another embodiment of a self-mailer article is depicted in FIGS. 14-17, wherein a sheet material 66 including the waste area 70 and the self-mailer article are separated by a plurality of waste area score lines 72. The self-mailer article comprises a primary panel 32, a rear panel 44 and rear panel fold line 46, a first flap 40 and first fold line 42, a second flap 54 and a second fold line 56, and a broad flap 50 and a broad flap fold line 52. The primary panel may also include slits 74 as described above. This embodiment differs from that of FIGS. 10-13 in that there is a single rear panel that is preferably of the same size as the primary panel, and a broad flap. Adhesive is preferably disposed on the broad flap and the first and second flaps. FIG. 15 depicts the self-mailer article separated from the waste area, wherein the rear panel 44 is folded in the foreground over the primary panel. FIG. 16 depicts the self-mailer of this embodiment fully folded, wherein the first 40 and second 54 flaps are folded after the broad flap 50, the broad flap itself being folded to overlie the rear panel 44. FIG. 17 illustrates the sequential folding of the embodiment of the self-mailer of FIGS. 14-16, although the sequence of folding is not limiting to the invention.

For each of the embodiments shown in FIGS. 10-17, a sheet material of standard 8.5″×11″ can be chosen and the resulting folded article will fit into a standard No.10 envelope (4.13″×9.5″). For each of the rear panels and flaps described above, whether a business card, a self-mailer, or any other article according to the present invention, an edge of the flap or rear panel opposite the associated fold line may be as depicted in FIGS. 1-17, or may be modified in any variety of edges, some of which are shown at FIGS. 18A-D. Additionally, any free edge of any panel or flap may be so modified, free edge being an edge that is not coincident with a fold line. Illustrative examples of such a free edge include the edge opposite the first fold line of FIGS. 1A, 4A and 6A, and any rear panel edge of FIGS. 2A, 3A, 5A, 8 and 9 that is not also a rear fold line or a broad fold line.

FIG. 19 shows a sheet material 66 adapted so that a plurality of articles according to the preferred embodiment may be removed therefrom. The sheet material 66 is as one measuring 8.5″×11″ but is not necessarily limited to that. Preferably, the sheet material is any size usable by desktop printers. Most preferably, the sheet material comprises a standard size page such as 8.5″×11″, A4, and legal. The sheet material defines a left gutter 68L, a right gutter 68R, a top gutter 68T and a bottom gutter 68B. Between the top and bottom gutters are two columns of business cards according to FIG. 1A, four of which will be described in detail. A first article 76A comprises a primary panel 78A defining a display face 80A and a flap 82A separated from the primary panel by a fold line 84A. A second article 76B comprises a primary panel 78B defining a display face (not shown) and a flap 82B separated from the primary panel by a fold line 84B. Third and fourth articles, 76C and 76D respectively, comprise like components identified by the same reference numbers but with the suffix C and D, respectively. The first and third articles 76A and 76C are adjacent to the left gutter 68L and separated from one another by a separation score line 86H. The flaps 82A and 82C of the first and third articles lie at least partly within the left gutter 68L, and their display faces 80A and 80C lie on the sheet material face 88 that is illustrated at FIG. 19. The sheet material necessarily includes an opposing reverse face not shown in FIG. 19, and adhesive is preferably disposed on that opposing reverse face at the flaps 82A and 82C.

The second and third articles, 76B and 76D respectively, are adjacent to the right gutter 68R and separated from one another by a separation score line 86H. The second and fourth articles are further separated by the first and third articles by another separation score line 86V. The flaps 82B and 82D of the second and fourth articles lie at least partly within the right gutter 68R. Adhesive 48 is preferably disposed on the sheet material face 88 at the flaps 82B and 82D. The second and fourth article display faces (not shown) preferably lie on the sheet material reverse face. Alternatively, all display faces 80A-D may lie on the same face 88 of the sheet material, and all adhesive would be disposed on the reverse face.

The sheet material 66 may be adapted such that a plurality of any of the articles shown in FIGS. 1-9 may be removed therefrom. The articles of the preferred embodiment of FIG. 1 yields the least waste area 70 and the maximum number of articles per page than the other depicted embodiments, but other embodiments may be selected for different uses.

The sheet material of the present invention can thereby be fed into a desktop printer or the like and printed upon for a user's particular use, such as a business card tailored to a particular trade show or a temporary title/address, a self-mailer individualized to the recipient, etc. The user can employ a variety of colors, designs, and text for particular situations where the volume of articles desired does not justify the cost of a commercial printer, or where time does not allow a commercial print run.

While the preferred embodiment and several modifications have been shown and described, additional various changes and substitutions will be apparent to those skilled in the art and may be made without departing from the spirit and scope of the present invention. The embodiment described above are hereby stipulated as illustrative rather than exhaustive.

What is claimed is:

1. A sheet material for receiving a predetermined image printed thereon by a printer having a plurality of rollers which selectively engage gutter areas of said sheet material, said sheet material comprising:
a primary panel defined on said sheet material;
a flap defined on said sheet material, said flap and said primary panel mated about a common fold line;
said primary panel and said flap being detachable from said sheet material via an inscribed line of detachment forming a boundary of said primary panel and said flap; and
wherein one of said primary panel and said flap are at least partially defined in said gutter areas of said sheet material.

2. The sheet material for receiving a predetermined image printed thereon according to claim 1, wherein:
said gutter areas extend along edge portions of said sheet material.

3. The sheet material for receiving a predetermined image printed thereon according to claim 1, wherein:
said predetermined image comprises one of a text image and a graphic image.

4. The sheet material for receiving a predetermined image printed thereon according to claim 1, further comprising:
an adhesive disposed on one of said primary panel and said flap; and
wherein said adhesive secures said primary panel to said flap when said primary panel and said flap are folded onto each other about said common fold line.

5. The sheet material for receiving a predetermined image printed thereon according to claim 1, wherein:
said sheet material comprises a plurality of primary panels and flaps defined thereon.

6. The sheet material for receiving a predetermined image printed thereon according to claim 1, further comprising:
a rear panel mated to said primary panel about a second fold line; and
said rear panel being detachable from said sheet material via said inscribed line of detachment, said line of detachment forming said boundary of said primary panel, said flap and said rear panel.

7. The sheet material for receiving a predetermined image printed thereon according to claim 1, wherein:
said line of detachment comprises a perforated line.

8. The sheet material for receiving a predetermined image printed thereon according to claim 6, wherein:
said sheet material comprises a plurality of primary panels, flaps and rear panels defined thereon.

9. An article of personal communication made from a single layer of sheet material comprising:
a primary panel for displaying a primary printed message; and
a flap fixed to the primary panel at a first fold line, wherein said flap is folded along said first fold line to lie behind said primary panel.

10. The article of claim 9, further comprising:
a rear panel fixed to the primary panel at a second fold line and folded along the second fold line to lie behind said primary panel.

11. The article of claim 10, wherein:
at least a portion of said rear panel is disposed between said flap and said primary panel.

12. The article of claim 10, further comprising:
an adhesive disposed between said primary panel and said rear panel.

13. The article of claim 10, wherein:
said first edge is adjacent to said second edge.

14. The article of claim 9, further comprising:
an adhesive disposed between said rear panel and said flap.

15. The article of claim 9, wherein:
an area defined by a largest surface of said flap is about one third of an area defined by a largest surface of said primary panel.

16. The article of claim 15, wherein:
said area defined by the largest surface of said flap is about one fifth of said area defined by the largest surface of said primary panel.

17. A single layer of sheet material comprising:
a waste area;
at least one article of personal communication comprising a primary panel defining a display face, a first flap, and a first fold line therebetween, and
at least one score line disposed between said waste area and said article.

18. The single layer of sheet material of claim 17, wherein:
a single layer of sheet material defines a first gutter, and said first flap is disposed at least partially within the first gutter.

19. The single layer of sheet material of claim 17, wherein:
said article further comprises a second fold line between said primary panel and a second flap.

20. The single layer of sheet material of claim 19, wherein:
said single layer of sheet material further defines a second gutter that is not adjacent to the first gutter, said second flap disposed at least partially in said second gutter.

21. The single layer of sheet material of claim 19, wherein:
said article further comprises a lower rear panel and a third fold line between said lower rear panel and said primary panel.

22. The single layer of sheet material of claim 21, wherein:
said article further comprises a broad flap and a broad fold line between said broad flap and said primary panel.

23. The single layer of sheet material of claim 22, wherein:
said broad fold line and said third fold line are each adjacent to both the first and the second fold lines.

24. The single layer of sheet material of claim 23, wherein:
said broad fold line is not adjacent to both the first fold line and the second fold line.

25. The single layer of sheet material of claim 23, wherein:
said article further comprises an adhesive disposed on at least a portion of said broad flap.

26. The single layer of sheet material of claim 21, wherein:
said article further comprises an upper rear panel and a fourth fold line between said upper rear panel and said primary panel.

27. The single layer of sheet material of claim 17, further comprising:
an adhesive disposed on at least a portion of said first flap.
